(19) United States
(12) Patent Application Publication
(10) Pub. No.: US 2019/0095282 A1
(43) Pub. Date: Mar. 28, 2019

(54) INFORMATION PROCESSING APPARATUS, INFORMATION PROCESSING SYSTEM, AND CONTROL METHOD BY THE SAME

(71) Applicants: KABUSHIKI KAISHA TOSHIBA, Tokyo (JP); TOSHIBA TEC KABUSHIKI KAISHA, Tokyo (JP)

(72) Inventor: Takanori Fukuhara, Mishima Shizuoka (JP)

(21) Appl. No.: 15/713,896

(22) Filed: Sep. 25, 2017

(51) Int. Cl. G06F 11/14; G06F 17/30; H04N 1/32; H04N 1/00

(52) U.S. Cl. CPC G06F 11/1402; G06F 17/3007; H04N 2201/0094; H04N 1/00029; H04N 1/00084; H04N 1/32667

(57) ABSTRACT

In accordance with an embodiment, an information processing apparatus comprises a storage device and a controller. The storage device stores system information relating to a system of the information processing apparatus. The controller executes a recovery processing on the storage device using recovery information stored in a storage medium for storing the recovery information necessary for recovering the system information.

### FIELD

Embodiments described herein relate generally to an information processing apparatus, an information processing system, and a control method by the information processing apparatus.

### BACKGROUND

In an information processing apparatus such as an MFP (Multi-Function Peripheral), an HDD (Hard Disk Drive) or an SSD (Solid State Drive) is used as a storage device that stores an OS (Operating System), an application and the like used to control the information processing apparatus. In the HDD or the SSD, if power is cut off during a writing operation, there is no guarantee that data being written is completely written. Therefore, if the written data is management information of a file system and the file is damaged by an interruption in the writing operation, it becomes impossible to access the file, or it becomes impossible to access a directory to which the file is written. In this way, if the file of the directory is damaged, there is a case in which other files in that directory cannot be accessed. For this reason, in the information processing apparatus having the HDD, an error detection is executed by retrieving a file accessed for writing, and meanwhile, restoration of the data and the file is executed by executing a recovery processing of the file and the data on the file in which an error is detected based on file information stored in a storage section other than the HDD. However, by such a restoration method of the file and the directory, there is a case in which system control and file management become complicated and dissemination becomes difficult due to file damage conditions.

### BRIEF DESCRIPTION OF THE DRAWINGS

FIG. 1 is an external view exemplifying the overall constitution of an information processing apparatus according to an embodiment;

FIG. 2 is a block diagram exemplifying the system constitution of the information processing apparatus according to the present embodiment;

FIG. 3 is a diagram exemplifying information stored in a storage medium according to the present embodiment;

FIG. 4 is a flowchart exemplifying processing procedures of detection, restoration, and repair of a system error stored in an HDD according to the present embodiment;

FIG. 5 is a flowchart exemplifying the processing procedures of the detection, the restoration and the repair of the system error stored in the HDD according to the present embodiment;

FIG. 6 is a diagram exemplifying the system constitution in which the information processing apparatus according to the present embodiment is connected to a server device via a network;

FIG. 7 is a flowchart exemplifying a processing procedure in a case of executing a recovery processing from the server device according to the present embodiment;

FIG. 8 is a diagram illustrating another example of information stored in the storage medium according to the present embodiment; and

FIG. 9 is a diagram exemplifying the system constitution in which a plurality of information processing apparatuses is connected according to the present embodiment.

### DETAILED DESCRIPTION

In accordance with an embodiment, an information processing apparatus comprises a storage device and a controller. The storage device stores system information relating to a system of the information processing apparatus. The controller executes a recovery processing on the storage device using recovery information stored in a storage medium for storing the recovery information necessary for recovering the system information.

Hereinafter, an information processing apparatus, an information processing system, and a control method by the information processing apparatus of an embodiment are described with reference to the accompanying drawings. In the following embodiment, a multi-function peripheral is described as an example of the information processing apparatus.

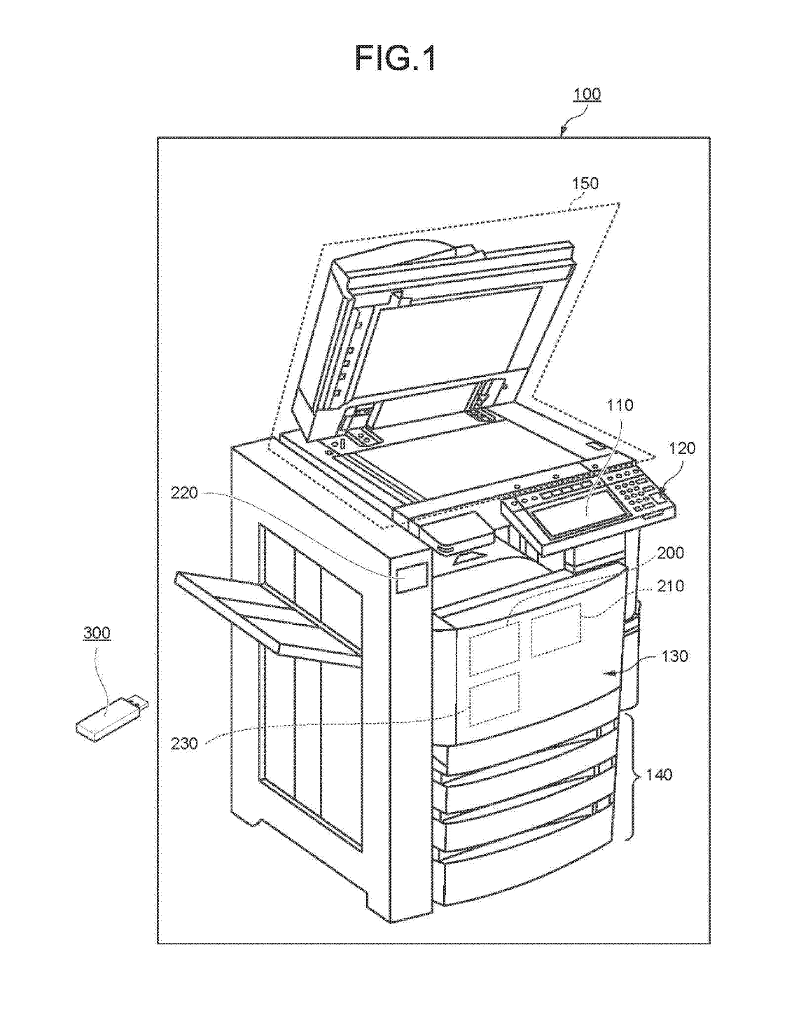

FIG. 1 is an external view exemplifying the overall constitution of an information processing apparatus 100 according to the embodiment.

As shown in FIG. 1, the information processing apparatus 100 is a multifunction peripheral capable of forming a toner image on a sheet. The sheet is, for example, a document or a paper on which characters, images or the like are recorded. The sheet may be an optional object as long as it can be read by the information processing apparatus 100. The information processing apparatus 100 reads an image shown on the sheet and generates digital data to generate an image file.

The information processing apparatus 100 includes a display 110, a control panel 120, a printer section 130, a sheet housing section 140, an image reading section 150, a system controller 200, a storage device 210, a connection section 220 and a communication section 230 (connection section). The printer section 130 of the information processing apparatus 100 may fix a toner image. In the present embodiment, a case in which the printer section 130 fixes the toner image is described as an example.

The display 110 is an image display device such as a liquid crystal display, an organic EL (Electro Luminescence) display and the like. The display 110 displays various information relating to the information processing apparatus 100. The display 110 outputs a signal in response to an operation executed by a user to the information processing apparatus 100. The display 110 receives the operation by the user.

The control panel 120 includes a plurality of buttons. The control panel 120 receives an operation by the user. The control panel 120 outputs a signal in response to the operation executed by the user to the information processing apparatus 100. Further, the display 110 and the control panel 120 may be constituted as an integrated touch panel.

The printer section 130 executes an image forming processing. The printer section 130 forms an image on the sheet based on image information generated by the image reading section 150 or image information received via a communication path in the image forming processing.

The sheet housing section 140 houses the sheet used in the image formation by the printer section 130.

The image reading section 150 reads the image which is a reading object as intensity of light. For example, the image reading section 150 reads an image printed on the sheet which is the reading object set in the information processing apparatus 100. The image reading section 150 records the read image data. The recorded image data may be transmitted to another information processing apparatus via the network. The recorded image data may be used to form an image on the sheet by the printer section 130.

The system controller 200 controls the information processing apparatus 100 according to an OS (Operating System) and application stored in the storage device 210. The system controller 200 detects that a storage medium 300 is connected to the connection section 220, and if a program is recorded in the storage medium 300, the system controller 200 executes the stored program to execute a recovery processing using recovery information stored in the storage device 210. The recovery information and the recovery processing are described later. The system controller 200 controls communication between the communication section 230 and other information processing apparatuses 100 and a server device (storage medium) via wired network or wireless network.

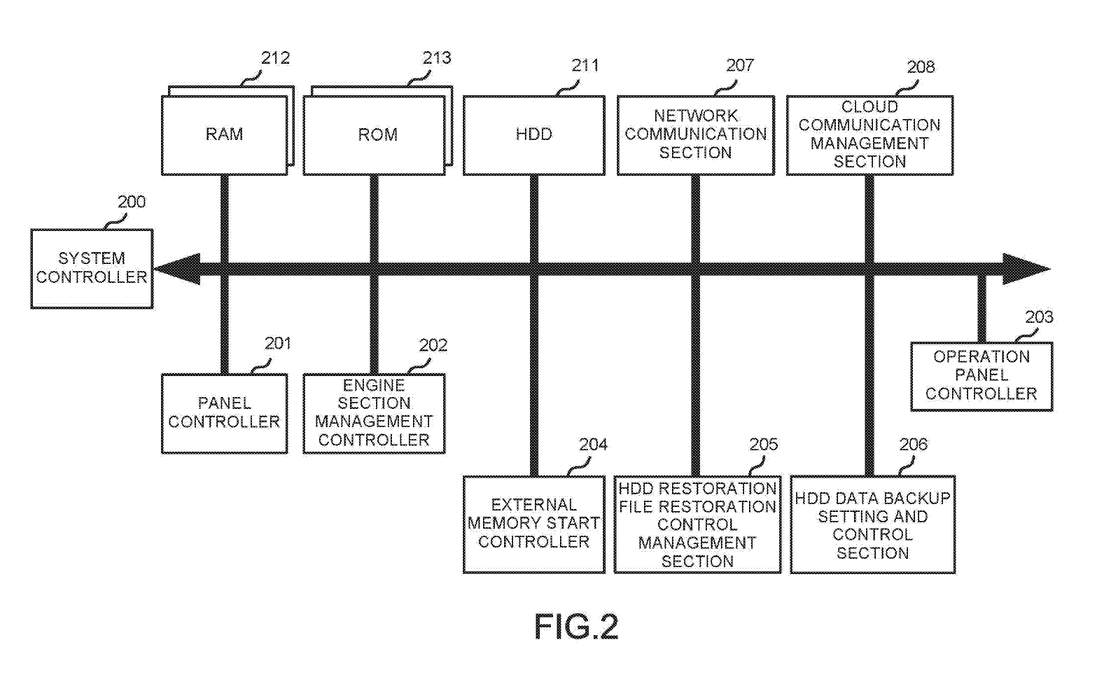

The storage device 210 is, for example, an HDD (Hard Disk Drive) or an SSD (Solid State Drive). The storage device 210 stores information such as the OS, the application or the like used for controlling the information processing apparatus 100. In the following description, an example in which an HDD 211 (FIG. 2) is used as the storage device 210 is described. The storage device 210 may store the generated image file.

The connection medium 220 is connected to the storage medium 300. The connection section 220 acquires the recovery information from the connected storage medium 300 under the control of the system controller 200.

The communication section 230 communicates with other information processing apparatuses 100 and the server device under the control of the system controller 200 via the wired network or the wireless network. Under the control of the system controller 200, the communication section 230 acquires the recovery information from other information processing apparatuses 100 and the server device connected via the network.

The storage medium 300 is, for example, a USB (Universal Serial Bus) memory (flash drive), a drive using a flash memory, a memory card, a reading device of an optical disk, a reading device of a magnetic tape, and the like. The information stored in the storage medium 300 is described later.

Next, an example of the system constitution of the information processing apparatus 100 is described.

FIG. 2 is a block diagram exemplifying the system constitution of the information processing apparatus 100 according to the present embodiment. As shown in FIG. 2, a system of the information processing apparatus 100 includes the HDD 211, a RAM (Random Access Memory) 212, a ROM (Read Only Memory) 213, the system controller 200, a panel controller 201, an engine section management controller 202, an operation panel controller 203, an external memory start controller 204, an HDD restoration file restoration control management section 205, an HDD data backup setting and control section 206, a network communication section 207, and a cloud communication management section 208.

The HDD 211 stores information such as the OS, the applications and the like used for controlling the information processing apparatus 100. The HDD 211 may store an image file generated by the information processing apparatus 100.

The RAM 212 temporarily stores information necessary for processing by the system controller 200. The RAM 212 may store the image file generated by the information processing apparatus 100.

The ROM 213 stores, for example, a BIOS (Basic Input Output System) necessary for the operation of the system controller 200. The BIOS includes a system disk started by a minimum system constitution. The system disk includes a program for executing an initialization program and the like stored in the storage medium 300 at the time the storage medium 300 is connected to the connection section 220.

The system controller 200 is, for example, a CPU (Central Processing Unit), a FPGA (Field-Programmable Gate Array), or the like. The system controller 200 starts the system according to the BIOS stored in the ROM 213. The system controller 200 controls each section of the system according to a detection result handled by the panel controller 201 or the operation panel controller 203, such as the OS and the application stored in the HDD 211. The system controller 200 reads the number of system errors of the HDD 211 at a predetermined timing. The predetermined timing refers to time of turning on the power, time of printing predetermined number of sheets, each predetermined time, and the like. If the number of system errors is equal to or larger than a predetermined value, the system controller 200 controls the HDD restoration file restoration control management section 205 to execute a restoration processing on information (hereinafter, also referred to as “system information”) of the system stored in the HDD 211. The system information refers to, for example, information necessary for start, directory information and the like. The system controller 200 controls the panel controller 201 to make a notification to urge the connection of the storage medium 300 to the connection section 220 if the restoration processing is executed a predetermined number of times or more. If the storage medium 300 is connected to the connection section 220, the system controller 200 controls the external memory start controller 204, the HDD restoration file restoration control management section 205, and the HDD data backup setting and control section 206 to carry out the recovery processing on the information stored in the HDD 211. Based on the information stored in the storage medium 300, the system controller 200 restores the system information stored in the HDD 211 by the recovery processing. If the system information stored in the HDD 211 cannot be recovered, the system controller 200 controls the HDD data backup setting and control section 206 to back up the system information. Alternatively, if the system information stored in the HDD 211 cannot be restored, the system controller 200 controls the panel controller 201 to notify that the system cannot be restored.

Under the control of the system controller 200, the panel controller 201 displays settings, error contents such as sheet runout, sheet jam or out of toner, a notification to urge connection of the storage medium 300 to the connection section 220 on the display 110 (FIG. 1). The panel controller 201 detects the result of operation on the display 110 by the user, and outputs the detection result to the system controller 200.

The engine section management controller 202 controls the printer section 130 (FIG. 1), the sheet housing section 140 (FIG. 1), the image reading section 150 (FIG. 1), etc. under the control of the system controller 200.

The operation panel controller 203 detects a result of an operation on the control panel 120 (FIG. 1) by the user, and outputs the detection result to the system controller 200.

The external memory start controller 204 detects that the storage medium 300 is connected to the connection section 220. If detecting the connection of the storage medium 300, the external memory start controller 204 determines whether or not predetermined information is stored in the storage medium 300. The predetermined information is, for example, the initialization program, the OS, the system restoration program, an HDD diagnosis program, and the like. If detecting that the storage medium 300 stores the predetermined information, the external memory start controller 204 performs control to start the information processing apparatus 100 using the system disk stored in the storage medium 300.

Under the control of the system controller 200, the HDD restoration file restoration control management section 205 executes a processing to restore the system information stored in the HDD 211. The processing to restore the system information is described later.

For example, the HDD data backup setting and control section 206 controls the backup of the predetermined information stored in the HDD 211 to an empty area of the connected storage medium 300 under the control of the system controller 200. Alternatively, if the server device is connected via the communication section 230, the HDD data backup setting and control section 206 performs control to back up the predetermined information stored in the HDD 211 to the server device. The predetermined information refers to, for example, information received if the information processing apparatus 100 has a facsimile function and image information read if the information processing apparatus 100 has a scanner function.

The network communication section 207 controls communication with other information processing apparatuses 100 connected via the network under the control of the system controller 200. The network may be the wired network or the wireless network.

The cloud communication management section 208 controls communication with the server device connected via the network under the control of the system controller 200. The network may be the wired network or the wireless network.

The panel controller 201, the engine section management controller 202, the operation panel controller 203, the external memory start controller 204, the HDD restoration file restoration control management section 205, the HDD data backup setting and control section 206, the network communication section 207, and the cloud communication management section 208 may be realized by software, for example.

Next, an example of the information stored in the storage medium 300 is described.

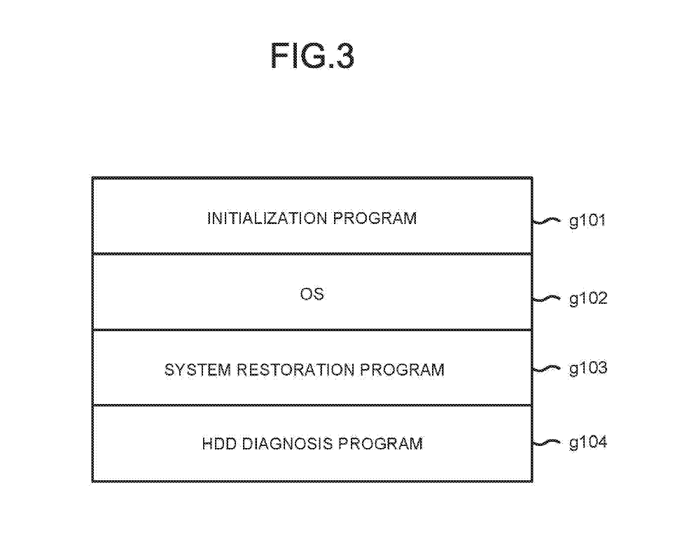

FIG. 3 is a diagram exemplifying the information stored in the storage medium 300 according to the present embodiment. As shown in FIG. 3, the storage medium 300 stores an initialization program g101, an OS g102, a system restoration program g103, and an HDD diagnosis program g104. In the present embodiment, the initialization program g101, the OS g102, the system restoration program g103, and the HDD diagnosis program g104 are referred to as the recovery information.

The initialization program g101 includes a system disk for starting the information processing apparatus 100 and a factory default system.

For example, the OS g102 is constituted by information equivalent to the OS stored in the HDD 211 or information limited to basic information necessary for start.

The system restoration program g103 is, for example, a program for restoring the system information stored in the HDD 211.

The HDD diagnosis program g104 is, for example, a program for diagnosing information stored in the HDD 211 and diagnosing the HDD 211.

Next, an example of the processing procedures of the detection, the restoration and the repair of the system error stored in the HDD 211 is described.

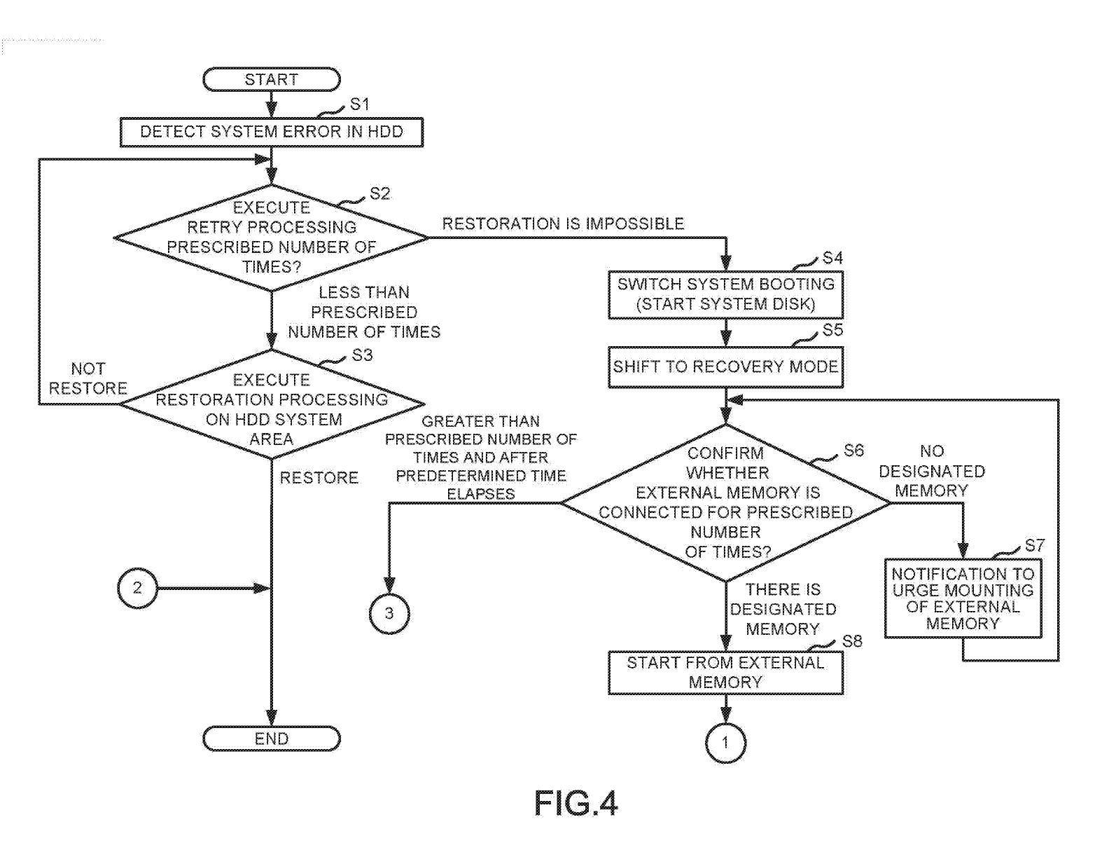

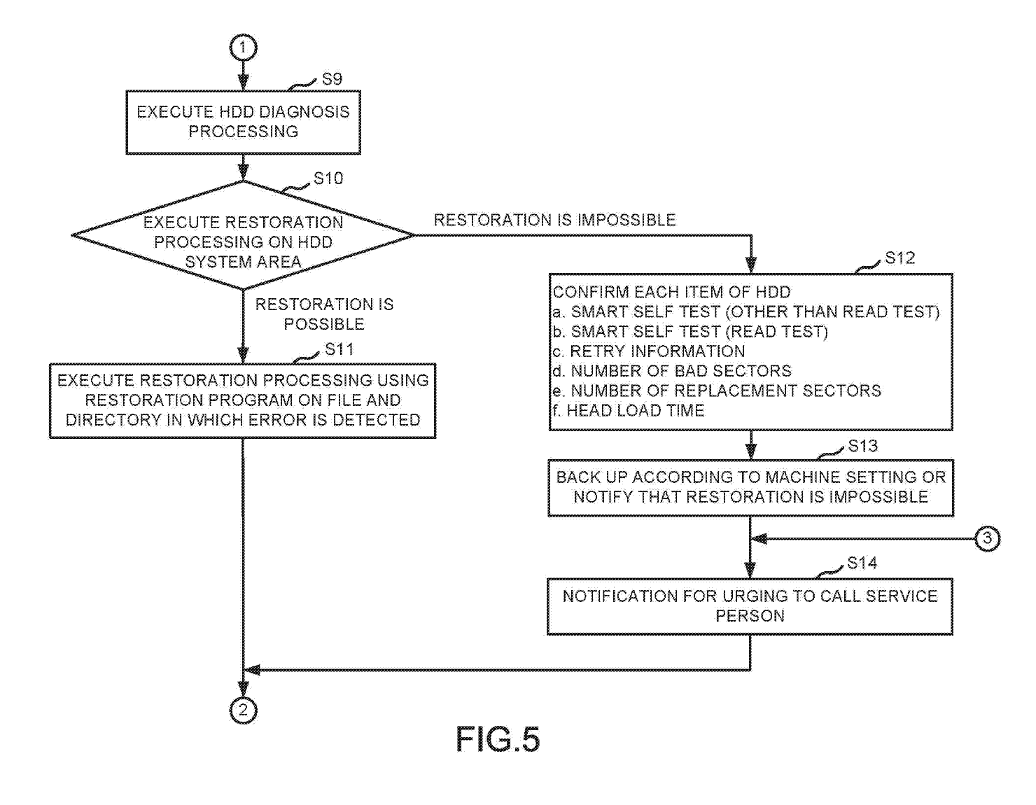

FIG. 4 and FIG. 5 is a flowchart exemplifying the processing procedures of the detection, the restoration and the repair of the system error stored in the HDD 211 according to the present embodiment.

(Act S1) The system controller 200 reads out the number of system errors of the HDD 211 at a predetermined timing. The system controller 200 stores the number of errors generated by reading and writing to the HDD 211 in the HDD 211, and reads the stored number of errors.

(Act S2) The system controller 200 determines whether or not the number of system errors is equal to or greater than a predetermined value. If the number of the system errors is equal to or greater than the predetermined value and less than the prescribed number of times (Act S2, less than prescribed number of times), the system controller 200 proceeds to the processing in Act S3. If the system information cannot be restored although the restoration processing in Act S3 is executed a prescribed number of times (Act S2, restoration is impossible), the system controller 200 proceeds to the processing in Act S4. The prescribed number of times is, for example, three times.

(Act S3) The system controller 200 controls the HDD restoration file restoration control management section 205 to execute the restoration processing on the system information stored in the HDD 211 in Act S3. The system controller 200 returns to the processing in Act S2 if the prescribed number of times is not reached and the restoration of the system information is not completed (Act S3, not restore). The system controller 200 terminates the restoration processing if the system information can be restored within the prescribed number of times (Act S3, restore).

(Act S4) The system controller 200 switches the area for starting (booting) the system to start the system from the system disk stored in the ROM 213.

(Act S5) The system controller 200 shifts to a recovery mode for executing the recovery processing.

(Act S6) The external memory start controller 204 detects whether or not the storage medium 300 is connected to the connection section 220 the prescribed number of times. The prescribed number of times is five times. The external memory start controller 204 proceeds to the processing in Act S7 if determining the storage medium 300 is not connected to the connection section 220 within the prescribed number of times (Act S6, no designated memory). If determining that the storage medium 300 is connected to the connection section 220 (Act S6, there is the designated memory), the external memory start controller 204 proceeds to the processing in Act S8. For example, if the external memory cannot be detected even if the processing in Act S6 and Act S7 is executed beyond the prescribed number of times and a predetermined time further elapses, the system controller 200 proceeds to the processing in Act S14.

(Act S7) The system controller 200 controls the panel controller 201 to make a notification for urging the connection of the storage medium 300 to the connection section 220. The notification is, for example, a display on the control panel 120. If the control panel 120 includes a lamp, the notification is lighting and extinction of the lamp. If the control panel 120 includes an acoustic signal output section, the notification is made by an acoustic signal. If the processing in Act S6 and Act S7 is executed within the prescribed number of times, the system controller 200 returns to the processing in Act S6.

(Act S8) If detecting the connection of the storage medium 300, the external memory start controller 204 determines whether or not the predetermined information is stored in the storage medium 300. Then, if detecting that the storage medium 300 stores the predetermined information, the external memory start controller 204 starts the information processing apparatus 100 using the system disk stored in the storage medium 300.

The description is continued by proceeding to FIG. 5. (Act S9) After activation by the system disk stored in the storage medium 300, the system controller 200 starts the HDD diagnosis program stored in the storage medium 300 to execute a diagnosis processing on the system information of the HDD 211.

(Act S10) The system controller 200 starts the system restoration program stored in the storage medium 300 to execute the restoration processing on the system information of the HDD 211. As the restoration processing, first, the system controller 200 determines whether or not the restoration is possible based on the diagnosis result in Act S9. The system controller 200 proceeds to the processing in Act S11 if determining that the restoration is possible (Act S10, restoration is possible). If determining that the restoration is not possible (Act S10, restoration is impossible), the system controller 200 proceeds to the processing in Act S12.

(Act S11) The system controller 200 restores the file or directory in which the error is detected to the factory default system state stored in the storage medium 300 in response to the system restoration program stored in the storage medium 300. After the restoration processing, the system controller 200 ends the processing.

(Act S12) The system controller 200 executes or confirms the following items a to f to the HDD 211 and confirms them.

a. Execute a SMART Self test (other than reading)

b. Execute the SMART Self test (reading test)

c. Confirm retry information

d. Confirm the number of bad sectors

e. Confirm the number of replacement sectors

f. Confirm head load time

The SMART (Self-Monitoring Analysis and Reporting Technology) Self test refers to a self-diagnosis function built in the HDD 211. The retry information is a cumulative number counted up if the retrying is executed a predetermined number of times or more. The predetermined number of times is, for example, 32 times. The head load time refers to operation time of an actuator at the time of data loading (the time during which the head emerges on the medium). The items a to f described above are merely examples, and information on test results for the HDD, errors stored in the HDD, the retry, replacement candidate sectors (pending sectors) and the like may be confirmed.

After processing, the system controller 200 proceeds to the processing in Act S13.

(Act S13) The system controller 200 controls the HDD restoration file restoration control management section 205 to back up the predetermined information stored in the HDD 211 to the empty area of the connected storage medium 300. Alternatively, the system controller 200 controls the panel controller 201 to notify (display or notify) information indicating that the HDD 211 cannot be restored. After the processing, the system controller 200 proceeds to the processing in Act S14.

(Act S14) The system controller 200 controls the panel controller 201 to notify (display or notify) information for urging to call a service person or a service center because the HDD 211 cannot be recovered. After the processing, the system controller 200 ends the processing.

The storage medium 300 may be connected, for example, by an administrator of the information processing apparatus 100 or the service person of the information processing apparatus 100.

As described above, in the present embodiment, the information necessary for the recovery processing is not stored in the HDD 211 of the information processing apparatus 100 but in the external storage medium 300. Thus, according to the present embodiment, even if the system information of the HDD 211 is damaged, it is possible to execute recovery processing for the information processing apparatus 100 from the storage medium 300 of the external connection. Thus, according to the present embodiment, the information processing apparatus 100 can be restored without bringing down the system.

A flash drive and a memory card can be used as the storage medium 300. Since the flash drive and the memory card are easy to obtain, it becomes easy to handle services. Since the costs of the flash drive and the memory card are low, the cost of the system including a recovery processing environment can be reduced.

Since the recovery processing is executed from the storage medium 300, even if the information processing apparatus 100 is not connected to the network, or even if the system information is damaged and the information processing apparatus 100 cannot be connected to the network, according to the present embodiment, the information processing apparatus 100 can be restored.

In the example described with reference to FIG. 4 and FIG. 5, the recovery processing is executed using the information stored in the storage medium 300 connected to the connection section 220, but the present invention is not limited thereto. The system controller 200 may execute the recovery processing using information stored in the server device via the network.

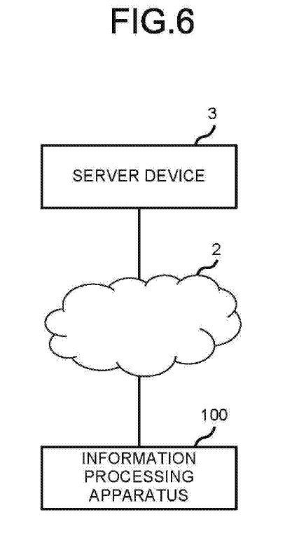

FIG. 6 is a diagram exemplifying the constitution of the information processing system in which the information processing apparatus 100 according to the present embodiment is connected to the server device via the network.

As shown in FIG. 6, the information processing apparatus 100 and a server device 3 (storage medium) are connected via a network 2. The network 2 is the wired network or the wireless network.

The server device 3 stores at least the initialization program, the OS, the system restoration program, and the HDD diagnosis program stored in the storage medium 300.

Next, an example of processing procedures for executing the recovery processing from the server device 3 is described.

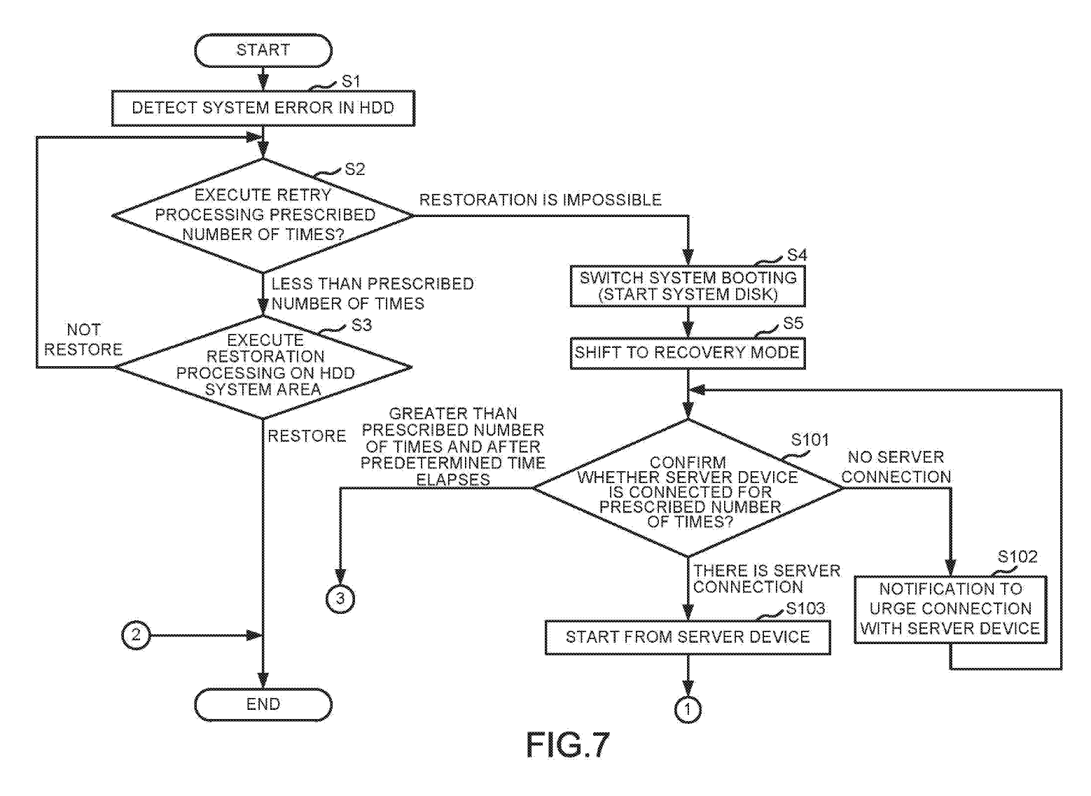

FIG. 7 is a flowchart exemplifying the processing procedures at the time of executing the recovery processing from the server device according to the present embodiment. For the processing same as those in FIG. 4, the same reference numerals are used and the description thereof is omitted.

(Act S5) The system controller 200 shifts to the recovery mode for executing the recovery processing. After the processing, the system controller 200 proceeds the processing in Act S101.

(Act S101) The external memory start controller 204 controls the network communication section 207 and the cloud communication management section 208 to determine whether or not the server device 3 is connected via the network 2 the prescribed number of times. The prescribed number of times is five times. The external memory start controller 204 proceeds to the processing in Act S102 if determining that the server device 3 is not connected via the network 2 within the prescribed number of times (Act S101, no server is connected). The external memory start controller 204 proceeds to the processing in Act S103 if determining that the server device 3 is connected via the network 2 (Act S101, server is connected). For example, if the connection of the server device 3 cannot be detected even if the processing in Act S6 and Act S7 is executed beyond the prescribed number of times and the predetermined time further elapses, the system controller 200 proceeds to the processing in Act S14 (FIG. 5).

(Act S102) The system controller 200 controls the panel controller 201 to make the notification to urge the connection of the server device 3 via the network 2. The notification is, for example, a display on the control panel 120. If the control panel 120 includes a lamp, the notification is lighting and extinction of the lamp. If the control panel 120 includes an acoustic signal output section, the notification is made by an acoustic signal. If the processing in Act S101 and Act S102 is executed within the prescribed number of times, the system controller 200 returns to the processing in Act S101.

(Act S103) If detecting the connection of the server device 3, the external memory start controller 204 determines whether or not the predetermined information is stored in the server device 3. If detecting that the server device 3 stores the predetermined information, the external memory start controller 204 performs the control to start the information processing apparatus 100 using the system disk stored in the server device 3. After the processing, the external memory start controller 204 proceeds to the processing in Act S9 (FIG. 5).

The processing in Act S9 to Act S14 is the same as the processing obtained by replacing the storage medium 300 with the server device 3 in the processing in FIG. 5.

As described above, according to the present embodiment, it is possible to execute the recovery processing on the information processing apparatus 100 from the server device 3 via the network 2. Thus, according to the present embodiment, the information processing apparatus 100 can be restored without bringing down the system.

In addition, in the example shown in FIG. 3, the storage medium 300 stores the initialization program, the OS, the system restoration program, and the HDD diagnosis program, but present invention is not limited thereto. Other information or diagnosis programs may be stored.

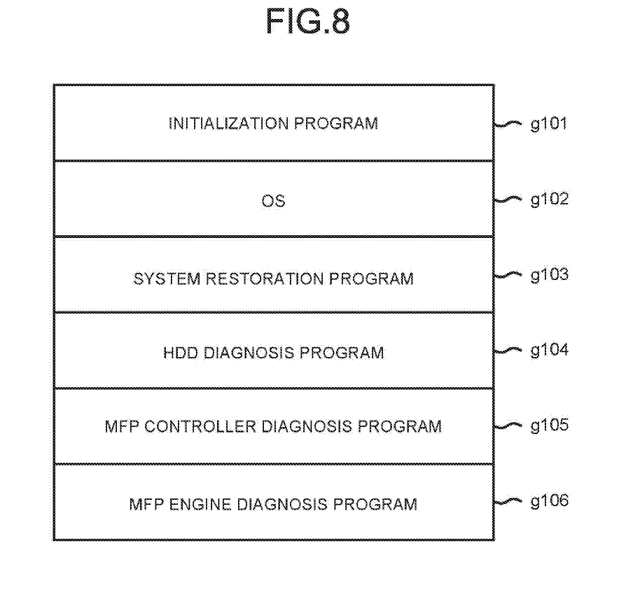

FIG. 8 is a diagram illustrating another example of the information stored in the storage medium 300 according to the present embodiment. As shown in FIG. 8, for example, the storage medium 300 may also store an MFP (Multi-Function Peripheral) controller diagnosis program g105, an MFP engine diagnosis program g106, and the like. For example, the MFP controller diagnosis program g105 diagnoses whether or not the processing controlled by the system controller 200 can be processed without errors. For example, the MFP engine diagnosis program g106 diagnoses whether or not the processing executed by the engine section management controller 202 can be processed without errors.

The server device 3 may also store the MFP controller diagnosis program, the MFP engine diagnosis program, and the like.

In the example shown in FIG. 6, one information processing apparatus 100 is described; however, the number of the information processing apparatuses 100 may be two or more.

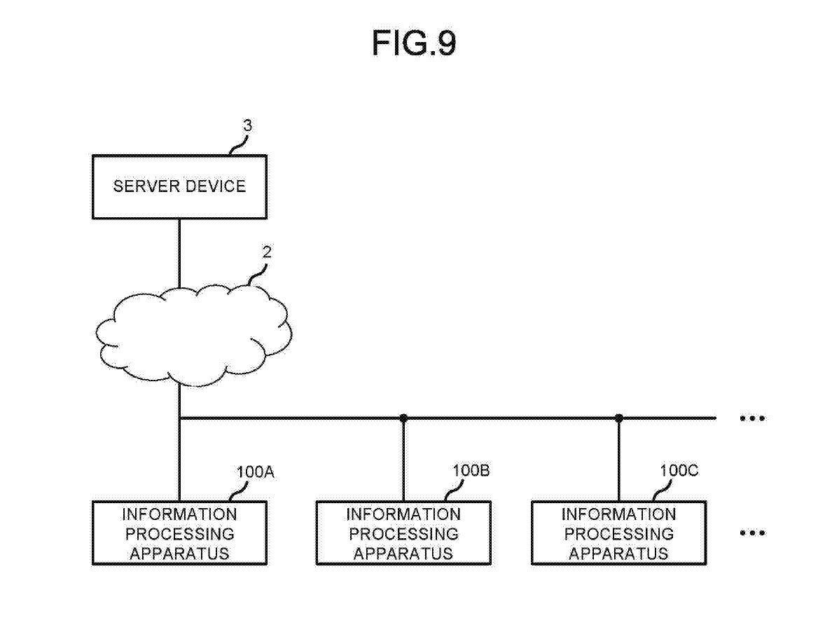

FIG. 9 is a diagram exemplifying the system constitution in which a plurality of the information processing apparatuses is connected according to the present embodiment. In the example shown in FIG. 9, a plurality of information processing apparatuses including an information processing apparatus 100A, an information processing apparatus 100B, an information processing apparatus 100C, . . . is connected to the network 2.

In the example shown in FIG. 9, the information processing apparatus 100A, the information processing apparatus 100B, the information processing apparatus 100C, . . . may execute the recovery processing according to the initialization program, the OS, the system restoration processing and the HDD diagnosis program stored in the server device 3 via the network 2.

As described above, according to the present embodiment, if a plurality of the information processing apparatuses including the information processing apparatus 100A, the information processing apparatus 100B, the information processing apparatus 100C, . . . is connected to the network 2, the recovery processing can be executed using the information stored in the server device 3 via the network 2. Thereby, according to the present embodiment, the restoration of the information processing apparatus 100A, the information processing apparatus 100B, the information processing apparatus 100C, . . . can be executed without bringing down the system.

Among the information processing apparatus 100A, the information processing apparatus 100B, the information processing apparatus 100C, . . . , the information processing apparatus 100A may be a master and the others may be slaves. In this case, the information processing apparatus 100A which is the master may execute the restoration processing (Act S2, Act S3; FIG. 4), the recovery processing (Act S6 to Act S14; FIG. 4 and FIG. 5) may be executed. In this case, the storage medium 300 may be connected to the connection section 220 of the information processing apparatus 100A, or the system controller 200 (FIG. 2) of the information processing apparatus 100A may execute the restoration processing and the recovery processing on the information processing apparatus 100 B which is the slave using the information stored in the server device 3 via the network 2.

In this way, the master and the slaves are separated in the plurality of the information processing apparatuses, and the information processing apparatus which is the master executes the restoration processing and the recovery processing on itself and the information processing apparatuses which are the slaves, and in this way, the function of the information processing apparatus which are slaves can be reduced and the cost can be reduced.

In the above embodiment, an example is described in which the panel controller 201, the engine section management controller 202, the operation panel controller 203, the external memory start controller 204, the HDD restoration file restoration control management section 205, the HDD data backup setting and control section 206, the network communication section 207, and the cloud communication management section 208 are software functional sections; however, they may be hardware functional sections such as LSI or the like.

According to at least one embodiment described above, by including the system controller 200 which has the connection sections (the connection section 220 and the communication section 230) connected to the device (the storage medium 300 or the server device 3) for storing the information necessary for the restoration processing and the recovery processing and which executes the restoration processing and the recovery processing using the information stored in the device which stores the information necessary for the restoration processing and the recovery processing, even if the file written to the storage device such as the HDD and the SDD is damaged, it is possible to execute the recovery processing on the file in the storage device.

In the above embodiment, the MFP is described as an example of the information processing apparatus 100; however, the present invention is not limited thereto. The information processing apparatus 100 may be, for example, a POS (Point Of Sales system) or the like as long as it has the storage device (HDD, SDD, etc.), the connection section, and the communication section.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. An information processing apparatus, comprising:
a storage device configured to store system information relating to a system of the information processing apparatus; and
a controller configured to execute a recovery processing on the storage device using recovery information stored in a storage medium for storing the recovery information necessary for recovering the system information.

2. The information processing apparatus according to claim 1, further comprising:
a connection section to which the storage medium for storing the recovery information necessary to recover the system information is connected,
the controller executes a recovery processing on the storage device using the recovery information stored in the storage medium if the storage medium is connected to the connection section.

3. The information processing apparatus according to claim 2, wherein
the controller initiates a notification to urge connection of the storage medium to the connection section if the storage medium is not connected to the connection section.

4. The information processing apparatus according to claim 1, wherein
the controller executes a self-diagnosis processing on the storage device using the recovery information stored in the storage medium.

5. The information processing apparatus according to claim 1, wherein
the recovery information comprises an initialization program, an operating system, a system restoration program, and an HDD diagnosis program.

6. The information processing apparatus according to claim 1, wherein
the storage medium is at least one of a flash drive, a memory card, an external storage device, an optical disk drive, a magnetic tape drive, a server device connected via a network, and other information processing apparatuses connected via the network.

7. The information processing apparatus according to claim 1, wherein
the storage device is either a hard disk drive or a solid state drive.

8. An information processing system comprising an information processing apparatus and a server device, wherein
the information processing apparatus and the server device are connected via a network,
the server device stores recovery information necessary for recovering system information of the information processing apparatus, and
the information processing apparatus comprises a storage device configured to store system information relating to a system of the information processing apparatus; and a controller configured to execute a recovery processing on the storage device using the recovery information stored in the server device.

9. The information processing system according to claim 8, wherein
the controller initiates a notification to urge connection of the storage medium to the connection section if the storage medium is not connected to the connection section.

10. The information processing system according to claim 8, wherein
the controller executes a self-diagnosis processing on the storage device using the recovery information stored in the storage medium.

11. The information processing system according to claim 8, wherein
the recovery information comprises an initialization program, an operating system, a system restoration program, and an HDD diagnosis program.

12. The information processing system according to claim 8, wherein
the storage medium is at least one of a flash drive, a memory card, an external storage device, an optical disk drive, a magnetic tape drive, a server device connected via a network, and other information processing apparatuses connected via the network.

13. The information processing system according to claim 8, wherein
the storage device is either a hard disk drive or a solid state drive.

14. An information processing system comprising a plurality of information processing apparatuses, wherein
the plurality of the information processing apparatuses are connected to one another via a network,
at least one of the plurality of the information processing apparatuses is a master, and the other information processing apparatuses are slaves,
the master information processing apparatus comprises a storage device configured to store system information relating to a system of the plurality of information processing apparatuses; and a controller configured to execute a recovery processing on a storage device comprised therein or a storage device of any of a slave information processing apparatus using recovery information stored in a storage medium for storing the recovery information necessary for recovering the system information.

15. The information processing system according to claim 14, comprising a plurality of slave information processing apparatuses.

16. The information processing system according to claim 14, wherein
the recovery information comprises an initialization program, an operating system, a system restoration program, and an HDD diagnosis program.

17. The information processing system according to claim 14, wherein
the storage medium is at least one of a flash drive, a memory card, an external storage device, an optical disk drive, a magnetic tape drive, a server device connected via a network, and other information processing apparatuses connected via the network.

18. The information processing system according to claim 14, wherein
the storage device is either a hard disk drive or a solid state drive.

19. A control method by an information processing apparatus having a storage device for storing system information relating to a system of the information processing apparatus, comprising:
confirming connection of a storage medium for storing recovery information necessary for recovering the system information to a connection section;
executing, by a controller, a recovery processing on the storage device using the recovery information stored in the connected storage medium if the storage medium is connected; and
performing, by the controller, a self-diagnosis processing on the storage device using the recovery information stored in the storage medium.

20. The control method according to claim 19, further comprising:
initiating a notification to urge connection of the storage medium if the storage medium is not connected to the controller.
